(19) United States
(12) Patent Application Publication
(10) Pub. No.: US 2013/0308806 A1
(43) Pub. Date: Nov. 21, 2013

(54) APPARATUS AND METHOD FOR COMPENSATION OF HEARING LOSS BASED ON HEARING LOSS MODEL

(71) Applicant: Samsung Electronics Co., Ltd., Suwon-si (KR)

(72) Inventors: Junil Sohn, Yongin-si (KR); Jongmin Choi, Seoul (KR); Dongwook Kim, Seoul (KR)

(21) Appl. No.: 13/897,717

(22) Filed: May 20, 2013

(30) Foreign Application Priority Data
May 18, 2012 (KR) 10-2012-0053239
Nov. 19, 2012 (KR) 10-2012-0126833

(51) Int. Cl. H04R 25/00

(52) U.S. Cl. CPC H04R 25/00
USPC 381/316

(57) ABSTRACT

A hearing loss compensation apparatus includes a filter bank control unit configured control a plurality of filter banks to separate an input signal into frequency bands; and a signal output unit configured to amplify the input signal separated into frequency bands according to a control parameter based on characteristics of a hearing loss patient, and output the amplified input signal.

### CROSS-REFERENCE TO RELATED APPLICATIONS

This application claims the benefit under 35 USC 119(a) of Korean Patent Application Nos. 10-2012-0053239 filed on May 18, 2012, and 10-2012-0126833 filed on Nov. 19, 2012, in the Korean Intellectual Property Office, the disclosures of which are incorporated herein by reference in their entirety for all purposes.

### BACKGROUND

1. Field

This disclosure relates to a hearing loss compensation apparatus and method for amplifying an input signal based on a hearing loss model of a hearing loss patient and outputting the amplified input signal.

2. Description of Related Art

Various methods for compensating for a hearing loss of a hearing loss patient have been introduced. Since causes of the hearing loss vary among hearing loss patients, characteristics of the hearing loss patients need to be considered to determine a hearing loss compensation method.

In addition, since signals input to ears of the hearing loss patient also vary, characteristics of the signals need to be taken into consideration. Otherwise, an adaptation rate and a satisfaction of the hearing loss patient may not be high enough even after the hearing loss is compensated.

### SUMMARY

In one general aspect, a hearing loss compensation apparatus includes a filter bank control unit configured to control a plurality of filter banks to separate an input signal into frequency bands; and a signal output unit configured to amplify the input signal separated into frequency bands according to a control parameter based on characteristics of a hearing loss patient, and output the amplified input signal.

The hearing loss compensation apparatus may further include a hearing loss model setting unit configured to set a hearing loss model of the hearing loss patient; and the signal output unit may be further configured to determine an amplification factor according to either one or both of an impairment level of an inner hair cell (IHC) and an impairment level of an outer hair cell (OHC) based on the hearing loss model.

The plurality of filter banks may include filter banks having different frequency characteristics for compensation of impairment of an inner hair cell (IHC) of the hearing loss patient and impairment of an outer hair cell (OHC) of the hearing loss patient.

The plurality of filter banks may include filter banks having frequency characteristics of a predetermined inner hair cell (IHC) and a predetermined outer hair cell (OHC).

In another general aspect, a hearing loss compensation apparatus includes a hearing loss model setting unit configured to set a hearing loss model of a hearing loss patient; a filter bank control unit configured control a plurality of filter banks to separate an input signal in the frequency domain into frequency bands; and a signal output unit configured to amplify the input signal separated into frequency bands according to the hearing loss model, and output the amplified input signal.

The plurality of filter banks may include filter banks having frequency characteristics related to an inner hair cell (IHC) and an outer hair cell (OHC).

The signal output unit may be further configured to amplify the input signal separated into frequency bands based on an impairment level of an inner hair cell (IHC) and an impairment level of an outer hair cell (OHC) based on the hearing loss model of the hearing loss patient.

In another general aspect, a hearing loss compensation method includes separating an input signal into frequency bands using a plurality of filter banks; amplifying the input signal separated into frequency bands according to a control parameter based on characteristics of a hearing loss patient; and outputting the amplified input signal.

The hearing loss compensation method may further include setting a hearing loss model of the hearing loss patient; and the amplifying of the input signal may include determining an amplification factor according to an impairment level of an inner hair cell (IHC) and an impairment level of an outer hair cell (OHC) based on the hearing loss model.

The plurality of filter banks may include filter banks having different frequency characteristics for compensation of impairment of an inner hair cell (IHC) of the hearing loss patient and impairment of an outer hair cell (OHC) of the hearing loss patient.

The plurality of filter banks may include filter banks having frequency characteristics of a predetermined inner hair cell (IHC) and a predetermined outer hair cell (OHC).

In another general aspect, a hearing loss compensation method includes setting a hearing loss model of a hearing loss patient; separating an input signal into frequency bands using a plurality of filter banks; amplifying the input signal separated into frequency bands according to the hearing loss model; and outputting the amplified input signal.

The plurality of filter banks may include filter banks having frequency characteristics related to an inner hair cell (IHC) and an outer hair cell (OHC).

The amplifying of the input signal may include amplifying the input signal separated into frequency bands based on an impairment level of an inner hair cell (IHC) and an impairment level of an outer hair cell (OHC) based on the hearing loss model of the hearing loss patient.

In another general aspect, a non-transitory computer-readable storage medium stores a program for controlling a computer to implement a method including separating an input signal into frequency bands using a plurality of filter banks; amplifying the input signal separated into frequency bands according to a control parameter based on characteristics of a hearing loss patient; and outputting the amplified input signal.

In another general aspect, a non-transitory computer-readable storage medium stores a program for controlling a computer to implement a method including setting a hearing loss model of a hearing loss patient; separating an input signal into frequency bands using a plurality of filter banks; amplifying the input signal separated into frequency bands according to the hearing loss model; and outputting the amplified input signal.

In another general aspect, a hearing loss compensation apparatus includes a filter bank; a filter bank control unit configured to control the filter bank to separate an input signal into a plurality of frequency bands; and a signal output unit configured to amplify the separated input signal in each of the frequency bands based on a hearing loss characteristic of a hearing loss patient to produce an amplified output signal.

The filter bank may include a plurality of filters; and the filter bank control unit may be further configured to set a frequency bandwidth of each of the filters based on the hearing loss characteristic.

The filter bank control unit may be further configured to set the frequency bandwidth of each of the filters so that the frequency bandwidth is inversely proportional to a rate of change of the hearing loss characteristic in a corresponding one of the frequency bands.

The filter bank may have a frequency characteristic of an inner hair cell (IHC) of a person with normal hearing or a frequency characteristic of an outer hair cell (OHC) of a person with normal hearing; and the hearing loss characteristic may include a hearing loss characteristic due to impairment of the IHC or a hearing loss characteristic due to impairment of the OHC.

The signal output unit may be further configured to amplify the separated input signal in each of the frequency bands based on a gain characteristic having a shape that is opposite to a shape of the hearing loss characteristic of the hearing loss patient.

In another general aspect, a hearing loss compensation apparatus includes a filter bank; a filter bank control unit configured to control the filter bank to separate an input signal into a plurality of frequency bands; and a gain control unit configured to control a gain applied to the separated input signal in each of the frequency bands to compensate for a hearing loss of a patient.

The filter bank may include a plurality of filters; and the filter bank control unit may be further configured to set a frequency bandwidth of each of the filters based on the hearing loss of the patient.

The hearing loss compensation apparatus may further include an output unit configured to combine amplified output signals in the frequency bands produced by the gain control unit to produce an amplified output signal that compensates for the hearing loss of the patient.

Other features and aspects will be apparent from the following detailed description, the drawings, and the claims.

### BRIEF DESCRIPTION OF THE DRAWINGS

FIG. 1 is a diagram illustrating an example of a hearing loss compensation apparatus.

FIG. 2 is a diagram illustrating a detailed structure of an example of a hearing loss compensation apparatus.

FIG. 3 is a diagram illustrating an anatomical structure of a portion of a human ear including inner hair cells (IHC) and outer hair cells (OHC) that when impaired cause a hearing loss.

FIG. 4 is a diagram illustrating examples of a hearing loss according to a hearing loss type.

FIG. 5 is a diagram illustrating an example of a process of hearing loss compensation based on a hearing loss model performed by an example of a hearing loss compensation apparatus.

FIG. 6 is a diagram illustrating an example of a result of hearing loss compensation based on a hearing loss type.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

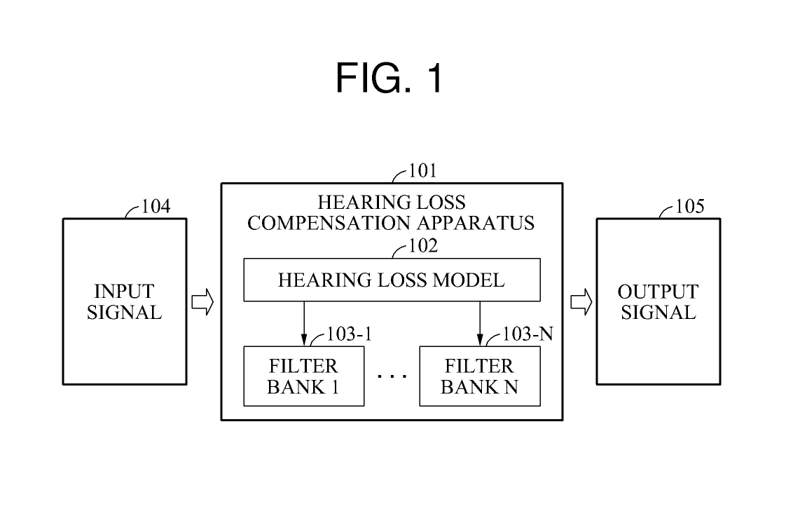

FIG. 1 is a diagram illustrating an example of a hearing loss compensation apparatus 101. The hearing loss compensation apparatus 101 may be included in a hearing aid, or may correspond to a hearing aid of a hearing loss patient. The hearing loss compensation apparatus 101 includes a hearing loss model 102 related to the hearing loss patient. The hearing loss model is used in compensating for a hearing loss caused when an inner hair cell (IHC) or an outer hair cell (OHC) present in an ear of the hearing loss patient is impaired.

The hearing loss may be classified into a conductive hearing loss and a sensorineural hearing loss. The conductive hearing loss may occur in the process of propagation of sound due to a disorder in either one or both of an external ear and a middle ear. The sensorineural hearing loss may occur in the process of conversion of sound into an electrical signal due to impairment of an auditory nerve cell, that is, a hair cell, and an auditory nerve present in the cochlea. The hearing loss model 102 and a plurality of filter banks 103-1 to 103-N are used to compensate for the sensorineural hearing loss caused by impairment of the IHC and the OHC of the hearing loss patient. Each of the plurality of filter banks 103-1 to 103-N may include a plurality of filters having different frequency bands.

In greater detail, the hearing loss compensation apparatus 101 separates an input signal 104 into frequency bands using the plurality of filter banks 103-1 to 103-N, each of which may include a plurality of filters having different frequency bands. Next, the hearing loss compensation apparatus 101 amplifies the input signal 104 separated into frequency bands by applying a gain, which is an amplification factor, for each of the frequency bands according to the hearing loss model 102. The hearing loss compensation apparatus 101 generates an output signal 105 by summing the amplified signals for each of the frequency bands into which the input signal 104 was separated.

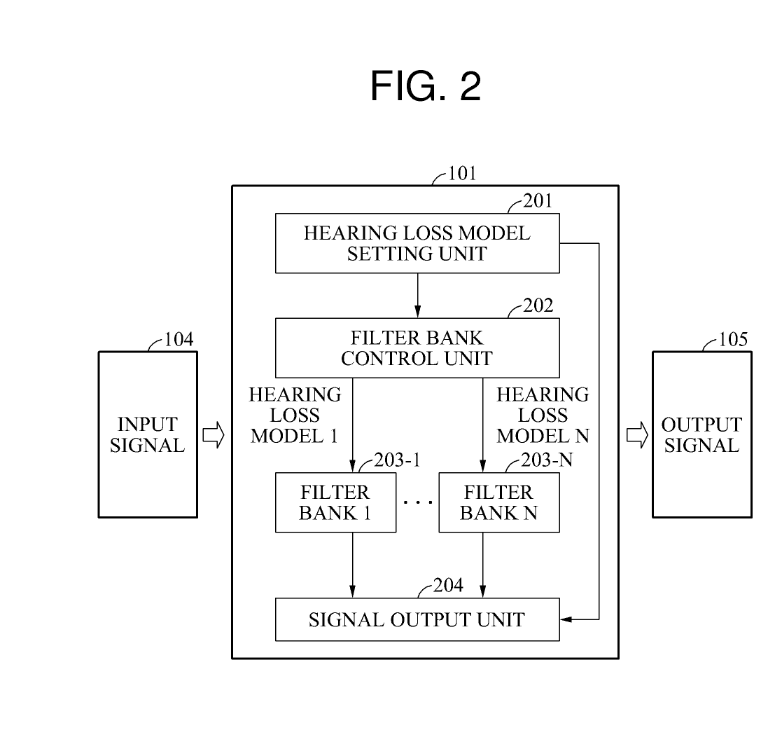

FIG. 2 is a diagram illustrating a detailed structure of an example of a hearing loss compensation apparatus 101. Referring to FIG. 2, the hearing loss compensation apparatus 101 includes a hearing loss model setting unit 201, a filter bank control unit 202, and a signal output unit 204.

The hearing loss model setting unit 201 sets a hearing loss model of a hearing loss patient. An impairment level of an IHC and an OHC of the hearing loss patient may be reflected in the hearing loss model. When a cause of the hearing loss of the hearing loss patient is not an impairment of the IHC and the OHC, the hearing loss model may reflect the cause of the hearing loss.

The filter bank control unit 202 separates the input signal 104, which has been transformed into the frequency domain, into the frequency bands using the plurality of filter banks 203-1 to 203-N, each of which may include a plurality of filters having different frequency bands. The plurality of filter banks 203-1 to 203-N may include filter banks having respectively different frequency characteristics for compensation of the IHC and the OHC of the hearing loss patient. That is, the plurality of filter banks 203-1 to 203-N may include filter banks having frequency characteristics of a predetermined IHC and a predetermined OHC.

Thus, using the plurality of filter banks 203-1 to 203-N, the filter bank control unit 202 separates the input signal 104 into signals recognizable by the IHC and the OHC of the hearing loss patient.

The signal output unit 204 amplifies the input signal separated into frequency bands using a control parameter based on characteristics of the hearing loss patient, and outputs the amplified input signal. In greater detail, the signal output unit 204 amplifies the input signal 104 separated into frequency bands in consideration of the impairment level of the IHC and the OHC based on the hearing loss model of the hearing loss patient, and generates the output signal 105 by summing up the amplified input signal for each of the frequency bands, that is, compensated signals. The control parameter may specify a number of frequency bands and a frequency bandwidth of each of the frequency bands.

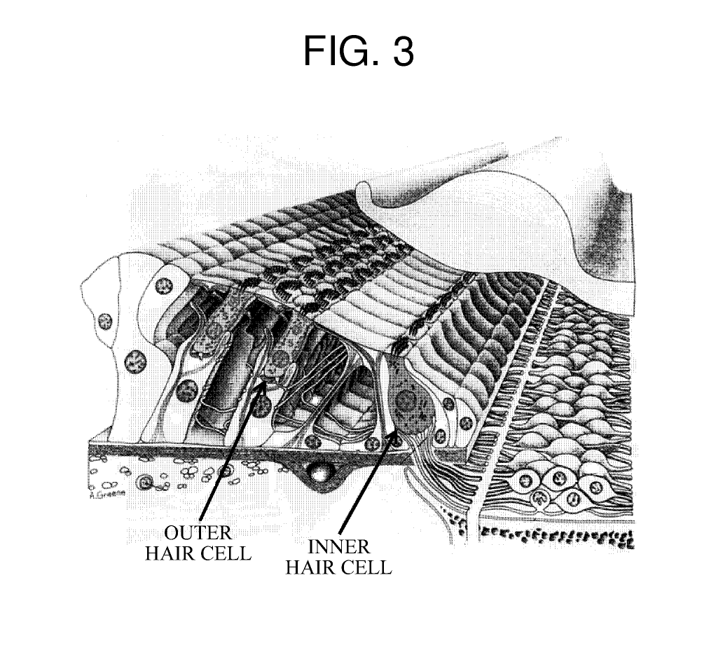

FIG. 3 is a diagram illustrating an anatomical structure of a portion of a human ear including inner hair cells (IHC) and outer hair cells (OHC) that when impaired cause a hearing loss type. The human ear includes a pinna, an external ear including an external auditory meatus, a middle ear including a tympanum and auditory ossicles, and an internal ear including a cochlea and three semicircular canals. As illustrated in FIG. 3, the cochlea includes outer hair cells (OHC) that amplify sound energy, and inner hair cells (IHC) that convert the amplified sound energy into electrical nerve signals. The IHCs include a ciliary bundle in which hairs ranging from about 10 to 50 micrometers in length are densely packed. The IHCs vibrate according to an input sound and the vibration is transmitted to nerves, thereby enabling a human to perceive the sound.

The hearing loss compensation apparatus presets an impairment level of an IHC or OHC of a hearing loss patient using the hearing loss model, and amplifies an input signal based on the hearing loss model so that the hearing loss patient perceives the input signal.

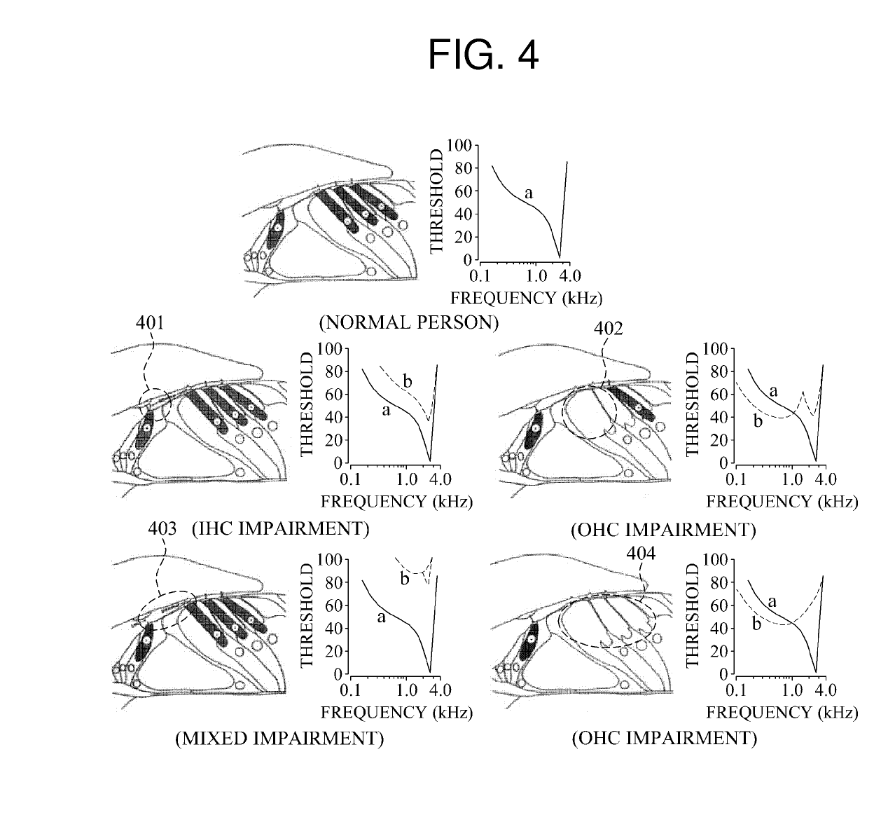

FIG. 4 is a diagram illustrating examples of a hearing loss according to a hearing loss type. FIG. 4 shows degrees of a hearing loss according to an impairment level of an IHC and an OHC. In FIG. 4, a graph ‘a’ indicates threshold versus frequency for perception of a sound by a normal person, and a graph ‘b’ indicates threshold versus frequency for perception of a sound by a hearing loss patient. The thresholds indicate amplitudes of signals in dB SPL (sound pressure level). As shown in the graph ‘a’ of FIG. 4, a threshold of a normal person for perception of a sound having a frequency of about 2.7 kHz is extremely low, that is, approximately zero. In this case, even if a signal input from outside has a low amplitude, since the low amplitude usually exceeds the threshold, the normal person may perceive a sound corresponding to the signal.

However, in case of a hearing loss patient whose IHC is impaired or a hearing loss patient whose OHC is impaired, the threshold in graph ‘b’ for perception of the sound having a frequency of about 2.7 kHz increases compared to the threshold in graph ‘a’. In FIG. 4, an impairment area 401 denotes a case in which the IHC is impaired, impairment areas 402 and 404 denote a case in which the OHC is impaired, and an impairment area 403 denotes a case in which the IHC and the OHC are both impaired.

In order for a hearing loss patient having the impaired IHC or OHC as in the impairment areas 401, 402, 403 and 404 to perceive an input sound having the frequency of about 2.7 kHz, the input sound needs to have an amplitude exceeding the threshold corresponding to the frequency of about 2.7 kHz at which the IHC or the OHC is impaired. However, since an input sound seldom exceeds the threshold corresponding to the frequency of about 2.7 kHz when the IHC or the OHC is impaired, the hearing loss patient may not perceive the sound having the frequency of about 2.7 kHz. When the IHC and the OHC are both impaired as in the impairment area 403, the threshold for perception of the sound having the frequency of about 2.7 kHz steeply increases compared to when only one of the IHC and the OHC is impaired as in the impairment areas 401, 402, and 404.

In this example, the input signal is amplified based on the hearing loss model indicating the impairment level of the IHC and the OHC so that the input signal exceeds the threshold corresponding to a case in which either one or both of the IHC and the OHC is impaired. Therefore, the hearing loss patient may perceive the signal input from the outside due to the amplification performed by the hearing loss compensation apparatus.

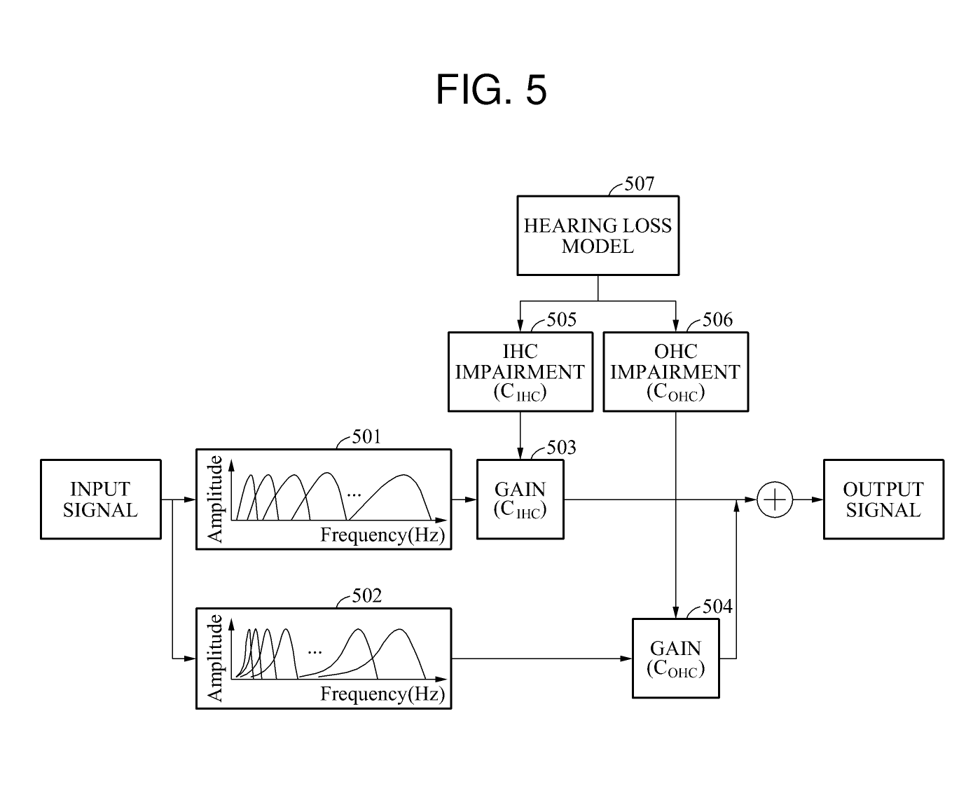

FIG. 5 is a diagram illustrating an example of a process of hearing loss compensation based on a hearing loss model performed by a hearing loss compensation apparatus. Referring to FIG. 5, the hearing loss compensation apparatus separates an input signal into frequency bands using filter banks 501 and 502, each of which may include a plurality of filters having different frequency bands as indicated by the multiple overlapping waveforms in each of the filter banks 501 and 502. Each of the overlapping waveforms corresponds to a different filter having a different frequency band. The filter banks 501 and 502 may refer to filter banks for compensating for an impairment of an IHC and an OHC. That is, when the IHC or the OHC of a hearing loss patient is impaired, compensation is separately performed based on whether the IHC or the OHC is impaired. Thus, a more accurate compensation may be achieved.

The filter banks 501 and 502 may have different frequency characteristics of a band pass filter. The band pass filter of the filter bank 501 may be designed to be similar to frequency characteristics of the IHC of a normal person, and the band pass filter of the filter bank 502 may be designed to be similar to frequency characteristics of the OHC of a normal person. The frequency characteristics of the band pass filter may be based on a tuning curve of a cochlea.

The hearing loss compensation apparatus sets a hearing loss model 507. The hearing loss model 507 indicates an impairment level 505 of the IHC and an impairment level 506 of the OHC of the hearing loss patient. Therefore, the hearing loss compensation apparatus applies an amplification factor 503 for compensation of the impairment level 505 of the IHC to the input signal separated into frequency bands by the filter bank 501, and an amplification factor 504 for compensation of the impairment level 506 of the OHC to the input signal separated into frequency bands by the filter bank 502. Next, the hearing loss compensation apparatus generates the output signal by summing the signals compensated according to the amplification factors 503 and 504. The amplification factor 503 is varied based on the amplitude of the input signal and a coefficient C_{IHC} indicating the impairment level 505 of the IHC. Also, the amplification factor 504 is varied based on the amplitude of the input signal and a coefficient C_{OHC} indicating the impairment level 506 of the OHC.

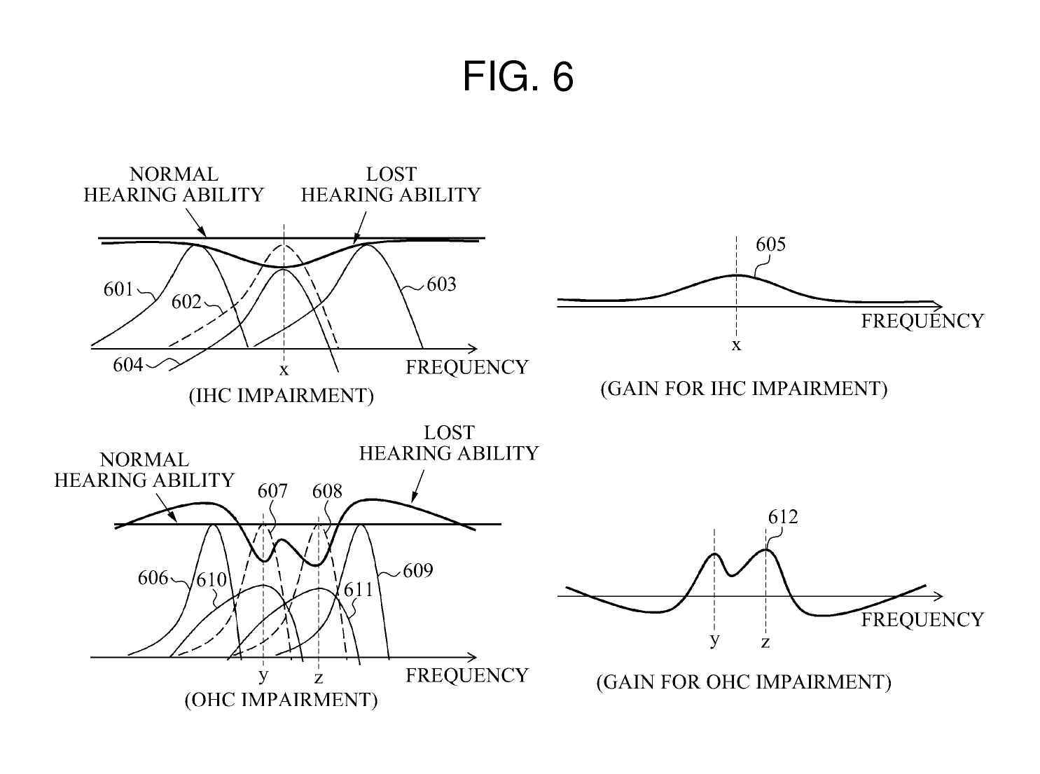

FIG. 6 is a diagram illustrating an example of a result of hearing loss compensation based on a hearing loss type. FIG. 6 shows lost hearing ability when an IHC is impaired (IHC impairment), and lost hearing ability when an OHC is impaired (OHC impairment). In FIG. 6, normal hearing ability refers to an amplitude of a signal perceivable by a normal person, and lost hearing ability refers to an amplitude of a signal perceivable by a hearing loss patient. In FIG. 6, when the IHC is impaired, signals 601, 602, and 603 correspond to the normal hearing ability in different frequency bands, and a signal 604 corresponds to the lost hearing ability in the frequency band of the signal 602 corresponding to the normal hearing ability. It is presumed that the hearing loss patient with the impaired IHC perceives the signal 604 having a lower amplitude than the signal 602 of the normal hearing ability at a frequency x. In this case, the hearing loss compensation apparatus applies a gain 605 for amplifying an input signal corresponding to the frequency x among input signals separated into frequency bands. The gain 605 is an amplification rate having a shape that is opposite to a shape of the lost hearing ability due to the impaired IHC. That is, the gain 605 increases as the lost hearing ability due to the impaired IHC decreases, and decreases as the lost hearing ability due to the impaired IHC increases. Therefore, the hearing loss patient may perceive the signal 602 at the frequency x correctly due to the gain 605 applied by the hearing loss compensation apparatus.

In FIG. 6, when the OHC is impaired, signals 606 to 609 correspond to the normal hearing ability in different frequency bands, and signals 610 and 611 correspond to the lost hearing ability in the frequency bands of the signals 607 and 608 corresponding to the normal hearing ability. It is presumed that the hearing loss patient with the impaired OHC perceives the signal 610 having a lower amplitude than the signal 607 of the normal hearing ability at a frequency y and the signal 611 having a lower amplitude than the signal 608 of the normal hearing ability at a frequency z. In this case, the hearing loss compensation apparatus applies a gain 612 for amplifying an input signal corresponding to the frequencies y and z among input signals separated into frequency bands. The gain 612 is an amplification rate having a shape that is opposite to a shape of the lost hearing ability due to the impaired OHC. That is, the gain 612 increases as the lost hearing ability due to the impaired OHC decreases, and decreases as the lost hearing ability due to the impaired OHC increases. Therefore, the hearing loss patient may perceive the signal 607 at the frequency y and the signal 608 at the frequency z correctly due to the gain 612 applied by the hearing loss compensation apparatus.

To compensate for the impairment of the IHC and the OHC, the hearing loss compensation apparatus may apply an amplification factor having a shape that is opposite to a shape of a lost hearing ability to an input signal. Thus, the hearing loss may be compensated. The amplification factor may be determined by the lost hearing ability based on the impairment level of the IHC and the OHC.

The hearing loss compensation apparatus 101, the hearing lost model 102, the plurality of filter banks 103-1 to 103-N, the hearing loss model setting unit 201, the filter bank control unit 202, the plurality of filter banks 203-1 to 203-N, and the signal output unit 204 described above that perform the operations illustrated in FIGS. 5 and 6 may be implemented using one or more hardware components, one or more software components, or a combination of one or more hardware components and one or more software components.

A hardware component may be, for example, a physical device that physically performs one or more operations, but is not limited thereto. Examples of hardware components include resistors, capacitors, inductors, power supplies, frequency generators, operational amplifiers, power amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A hearing loss compensation apparatus comprising:
a filter bank control unit configured to control a plurality of filter banks to separate an input signal into frequency bands; and
a signal output unit configured to amplify the input signal separated into frequency bands according to a control parameter based on characteristics of a hearing loss patient, and output the amplified input signal.

2. The hearing loss compensation apparatus of claim 1, further comprising a hearing loss model setting unit configured to set a hearing loss model of the hearing loss patient;
wherein the signal output unit is further configured to determine an amplification factor according to either one or both of an impairment level of an inner hair cell (IHC) and an impairment level of an outer hair cell (OHC) based on the hearing loss model.

3. The hearing loss compensation apparatus of claim 1, wherein the plurality of filter banks comprise filter banks having different frequency characteristics for compensation of impairment of an inner hair cell (IHC) of the hearing loss patient and impairment of an outer hair cell (OHC) of the hearing loss patient.

4. The hearing loss compensation apparatus of claim 1, wherein the plurality of filter banks comprise filter banks having frequency characteristics of a predetermined inner hair cell (IHC) and a predetermined outer hair cell (OHC).

5. The hearing loss compensation apparatus of claim 1, wherein the filter bank control unit is further configured to separate the input signal into signals recognizable by an inner hair cell (IHC) of the hearing loss patient and an outer hair cell (OHC) of the hearing loss patient using the plurality of filter banks.

6. The hearing loss compensation apparatus of claim 1, wherein the control parameter specifies a number of the frequency bands and a frequency bandwidth of the frequency bands.

7. The hearing loss compensation apparatus of claim 1, wherein the characteristics of the hearing loss patient comprise a hearing loss characteristic of the hearing loss patient; and
the filter bank control unit is further configured to set a frequency bandwidth of each of the filters based on the hearing loss characteristic.

8. The hearing loss compensation apparatus of claim 1, wherein the characteristics of the hearing loss patient comprise a hearing loss characteristic of the hearing loss patient; and
the filter bank control unit is further configured to set a frequency bandwidth of each of the filters so that the frequency bandwidth is inversely proportional to a rate of change of the hearing loss characteristic in a corresponding one of the frequency bands.

9. The hearing loss compensation apparatus of claim 1, wherein the plurality of filter banks comprise a filter bank having a frequency characteristic of an inner hair cell (IHC) of a person with normal hearing and a filter bank having a frequency characteristic of an outer hair cell (OHC) of a person with normal hearing; and
the characteristics of the hearing loss patient comprise a hearing loss characteristic due to impairment of the IHC of the hearing loss patient and a hearing loss characteristic due to impairment of the OHC of the hearing loss patient.

10. The hearing loss compensation apparatus of claim 1, wherein the characteristics of the hearing loss patient comprise a hearing loss characteristic of the hearing loss patient; and
the signal output unit is further configured to amplify the separated input signal in each of the frequency bands based on a gain characteristic having a shape that is opposite to a shape of the hearing loss characteristic.

11. A hearing loss compensation apparatus comprising:
a hearing loss model setting unit configured to set a hearing loss model of a hearing loss patient;
a filter bank control unit configured control a plurality of filter banks to separate an input signal in the frequency domain into frequency bands; and
a signal output unit configured to amplify the input signal separated into frequency bands according to the hearing loss model, and output the amplified input signal.

12. The hearing loss compensation apparatus of claim 11, wherein the plurality of filter banks comprise filter banks having frequency characteristics related to an inner hair cell (IHC) and an outer hair cell (OHC).

13. The hearing loss compensation apparatus of claim 11, wherein the signal output unit is further configured to amplify the input signal separated into frequency bands based on an impairment level of an inner hair cell (IHC) and an impairment level of an outer hair cell (OHC) based on the hearing loss model of the hearing loss patient.

14. The hearing loss compensation apparatus of claim 11, wherein the hearing loss model setting unit is further configured to set the hearing loss model so that the hearing loss model reflects an impairment level of an inner hair cell (IHC) of the hearing loss patient and an impairment level of an outer hair cell (OHC) of the hearing loss patient.

15. A hearing loss compensation method comprising:
separating an input signal into frequency bands using a plurality of filter banks;
amplifying the input signal separated into frequency bands according to a control parameter based on characteristics of a hearing loss patient; and
outputting the amplified input signal.

16. The hearing loss compensation method of claim 15, further comprising setting a hearing loss model of the hearing loss patient;
wherein the amplifying of the input signal comprises determining an amplification factor according to an impairment level of an inner hair cell (IHC) and an impairment level of an outer hair cell (OHC) based on the hearing loss model.

17. The hearing loss compensation method of claim 15, wherein the plurality of filter banks comprise filter banks having different frequency characteristics for compensation of impairment of an inner hair cell (IHC) of the hearing loss patient and impairment of an outer hair cell (OHC) of the hearing loss patient.

18. The hearing loss compensation method of claim 15, wherein the plurality of filter banks comprise filter banks having frequency characteristics of a predetermined inner hair cell (IHC) and a predetermined outer hair cell (OHC).
